(19) United States
(12) Patent Application Publication
(10) Pub. No.: US 2013/0110541 A1
(43) Pub. Date: May 2, 2013

(54) SOCIAL HEALTH NETWORKING

(71) Applicants: JAMES D. EATON, JR., GARDNER, KS (US); DAVID L. COMPTON, LENEXA, KS (US); MATTHEW NICHOLAS SAWKA, SMITHVILLE, MO (US)

(72) Inventors: JAMES D. EATON, JR., GARDNER, KS (US); DAVID L. COMPTON, LENEXA, KS (US); MATTHEW NICHOLAS SAWKA, SMITHVILLE, MO (US)

(73) Assignee: CERNER INNOVATION, INC., OVERLAND PARK, KS (US)

(21) Appl. No.: 13/283,727

(22) Filed: Oct. 28, 2011

(51) Int. Cl. G06Q 50/24

(52) U.S. Cl. 705/3

(57) ABSTRACT

Methods, systems, and computer storage media are provided for managing a social health network. Clinical information of users may be combined and distributed to users themselves or subscribers of users. Users may subscribe to other users in order to receive clinical information regarding one another. Varying levels of access may be assigned to users, clinical information, and the like to determine what information to distribute and to whom it should be distributed.

### BACKGROUND

Social networking has become increasingly common. Social networking, as used herein, refers generally to a web-enabled community that allows members to communicate with one another. Social networking is generally used for entertainment purposes, to keep in touch with contacts, and the like.

Healthcare environments are constantly seeking efficient means to promote health and to track clinical data. Due to the difficult nature of distributing clinical information, there is not a tool to manage clinical data from various sources, correlate the data from all of the sources, and efficiently distribute the data.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to managing a social health network. In particular, embodiments of the present invention relate to correlating clinical information of users and distributing clinical information to users. Users may subscribe to other users in order to receive clinical information regarding one another. Varying levels of access may be assigned to users, clinical information, and the like to determine what information to distribute and to whom it should be distributed.

Accordingly, in one aspect, the present invention is directed to one or more computer storage media storing computer-useable instructions that, when used by one or more computing devices, cause the one or more computing devices to perform a method. The method includes receiving an indication that clinical information for a first user is available. The indication may be automatically received upon input of information into a patient's electronic health record, for example. An access level is identified that is associated with the clinical information. For instance, clinical information may require a specified access level of a subscriber (e.g., unrestricted) in order for the subscriber to gain access to the clinical information. The clinical information is communicated to each of the one or more subscribers having an access level corresponding to the access level associated with the clinical information.

In another aspect, the present invention is directed to a computerized system for managing a social health network. The system includes a first receiving component for receiving clinical information for one or more users; a second receiving component for receiving one or more requests from one or more subscribers to access a health feed for at least one of the one or more users; an identifying component for identifying one or more access levels associated with one or more of the clinical information, the one or more users, and the one or more subscribers; and a communicating component for automatically communicating clinical information to the one or more subscribers based on the one or more access levels associated with the clinical information and the one or more subscribers.

In yet another aspect, the present invention is directed to one or more computer storage media storing computer-useable instructions that, when used by one or more computing devices, cause the one or more computing devices to perform a method. The method includes identifying a first set of clinical information associated with a first access level. A second set of clinical information associated with a second access level higher than the first access level is identified. A plurality of subscribers, each having varying access levels, is identified. The first set of clinical information is communicated to each of the plurality of subscribers associated with the first access level and both the first set of clinical information and the second set of clinical information are communicated to each of the plurality of subscribers associated with the second access level.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is an exemplary system architecture suitable to implement embodiments of the present invention;

FIG. 3 is a screenshot illustrating an exemplary health networking interface, in accordance with embodiments of the present invention;

FIG. 4 is a screenshot illustrating an exemplary health networking interface, in accordance with an embodiment of the present invention;

FIG. 5 is a flow diagram illustrating a first exemplary method of an embodiment of the present invention; and

FIG. 6 is a flow diagram illustrating a second exemplary method of an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention provide for systems, methods, and computer storage media for managing a social health network. In particular, embodiments of the present invention relate to correlating clinical information of users and distributing clinical information to users. Users may subscribe to other users in order to receive clinical information regarding one another. Varying levels of access may be assigned to users, clinical information, and the like to determine what information to distribute and to whom it should be distributed.

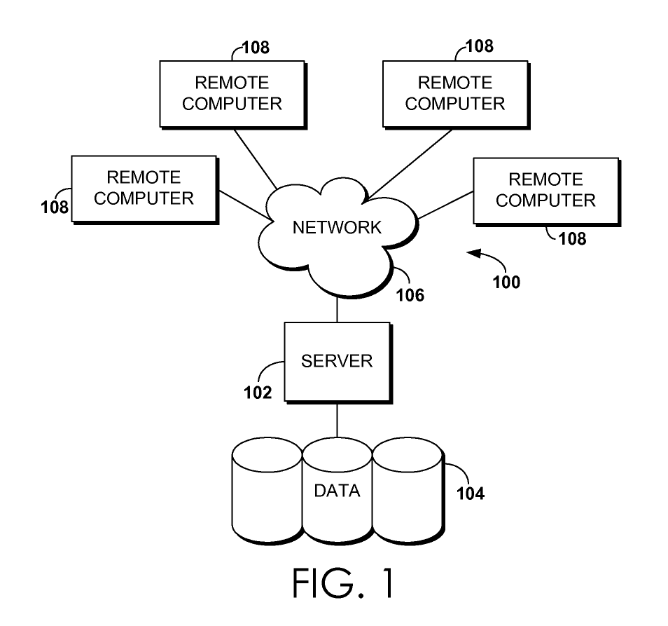

Having briefly described embodiments of the present invention, an exemplary operating environment suitable for use in implementing embodiments of the present invention is described below. Referring to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer-readable media, for instance, database cluster 104. Computer-readable media can be any available media that may be accessed by server 102, and includes volatile and nonvolatile media, as well as removable and non-removable media. By way of example, and not limitation, computer-readable media may include computer storage media and communication media. Computer storage media may include, without limitation, volatile and nonvolatile media, as well as removable and nonremovable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 104, provide storage of computer-readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home healthcare environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 108 may also be physically located in nontraditional medical care environments so that the entire healthcare community may be capable of integration on the network. The remote computers 108 may be personal computers, servers, routers, network PCs, peer devices, other common network nodes, or the like, and may include some or all of the components described above in relation to the server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnection are well known. Accordingly, additional details concerning the internal construction of the server 102 and the remote computers 108 are not further disclosed herein.

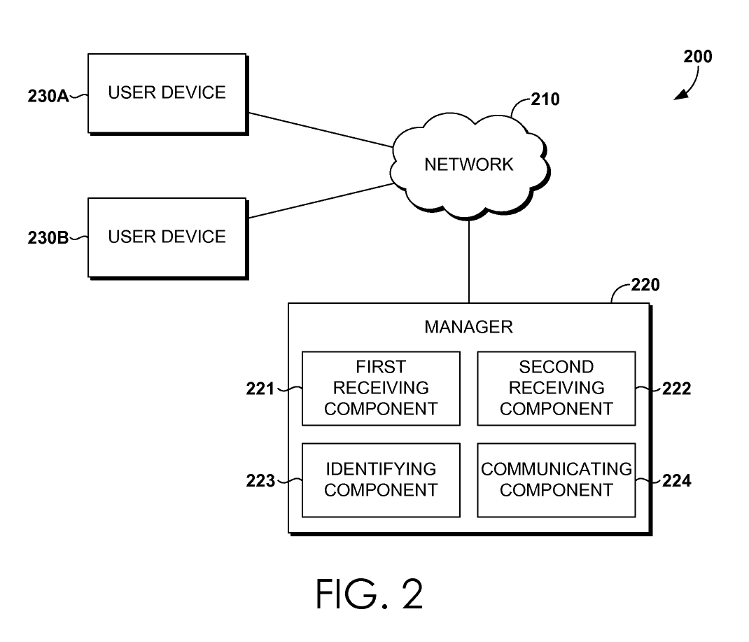

Turning to FIG. 2, an architectural framework 200 is shown for managing a social health network. This architectural framework 200 may operate, for instance, within the context of the exemplary medical information system 100 of FIG. 1. The system of FIG. 2 includes a network 210, a manager 220, and user devices 230A and 230B. Other components not shown here may also be used to carry out aspects of the present invention. For example, a clinical database may be utilized to store information used by the system 200 of FIG. 2. Further, several components shown in FIG. 2 may be combined into a single component although shown separately in FIG. 2. Alternatively, components, such as the manager 220, although shown as a single component, may actually be two or more components.

The manager 220 includes a first receiving component 221, a second receiving component 222, an identifying component 223, and a communicating component 224. Each component of the manager 220 may assist in managing a social health network. The manager 220 may be associated with a healthcare entity. Healthcare entities may include, but are not limited to, clinicians, hospitals, clinics, pharmacies, laboratories, and the like.

A social health network may be used to efficiently distribute clinical information about users. Clinical information, as used herein, refers generally to any data clinically related to a user. For instance, data related to a patient visit, a medical procedure, a test, a medication, a hospital stay, a patient history, immunization records, and the like, is clinical information.

Users may be a patient that is a subject of clinical information, a subscriber that will be notified of clinical information for the patient, a clinician, and the like. A subscriber, as used herein, refers generally to a user that has “subscribed” to another user's health network. Users may request permission to subscribe to another user. The user that is the subject of the request (i.e., the patient) may either accept the request or deny the request. By subscribing to a user's health network, the subscriber may be notified of clinical information, information related thereto, or the like. For instance, actual clinical information may be communicated to subscribers such as notifying a subscriber that the user is at a doctor's appointment and has been diagnosed with the flu. In another situation, related information may be communicated to subscribers such as notifying a subscriber that the user has received a work excuse at the doctor's office and will not be at work the next day. Users may designate any sort of notifications for various subscribers. For instance, a user may only wish to let a subscriber know if they are going to be away from their house for an extended period of time (e.g., for a hospital stay) that the subscriber should care for the user's pet in their absence. Additional examples may be discussed hereinafter.

Users and clinical information may be associated with an access level. An access level, as used herein, refers generally to a required permission granted to a user to access clinical information. Access levels may include various levels such as restricted, modified restricted, and unrestricted, and will be described in further detail below.

Returning to FIG. 2, first receiving component 221 is configured to receive clinical information. The clinical information may be received from a clinical database (not shown). The clinical information, as described above, may relate to any clinical event for a user. The clinical information may be made available via the user's health profile. A health profile, as used herein, refers generally to an access site to access a user's clinical information. In embodiments, a health profile is integrated into a web-enabled networking site. In alternative embodiments, a health profile is stored in a database and information is distributed to others as necessary. Regardless of where a health profile is accessible, clinical information may be automatically distributed to subscribers. In other words, a subscriber does not need to access a health profile to receive clinical information for a user to which he subscribes. Rather, clinical information is automatically “pushed” to the subscriber via a preferred method of communication. For instance, when clinical information for a user is received it is determined what sort of information should be distributed and to whom. Related to the above examples, a notification may be sent to a subscriber's mobile phone that they should feed and water a user's pet due to an extended absence. Alternatively, a notification may be sent to a subscriber's e-mail account indicating that the user is ill and will not be reporting to work that day.

The manager 220 also includes second receiving component 222 that is configured to receive requests from subscribers. The requests may be to gain access to a user's health feed of clinical information. In other words, the request is to become a subscriber to clinical information of a user such that the user's clinical information is automatically sent to the subscriber. Second receiving component 222 may be integrated into first receiving component 221.

Once a request is received by second receiving component 222, a user has an option to either accept the request or deny the request. Thus, a user maintains control over who may gain access to their clinical information and any information related thereto. For instance, if an acquaintance of a user requests access to the user's health feed, the user may allow the acquaintance to have access or may deny access.

In addition to either accepting or denying the request, the user may also assign an access level to the subscriber. Access levels may be individually assigned to subscribers. Alternatively, a user may indicate a set of rules to determine an access level for a subscriber. For instance, a rule set may exist that indicates any clinician granted access to the user's clinical information is automatically assigned an access level that allows full access to the user's clinical information. Alternatively, clinicians may be categorized such that only certain clinical information is available to them. For example, a pharmacist may not be granted full access but, rather, may be granted access only to clinical information dealing with medications of the user.

Access levels may be designated in any way to distinguish varying levels of access among users. In an embodiment, the access levels are unrestricted, modified restricted, and restricted. Unrestricted, as used herein, refers generally to an access level granting full access of the clinical information such that a subscriber may be notified of all clinical information. Restricted, as used herein, refers generally to an access level that does not allow access to clinical information but may allow access to some information related to the clinical information. Modified restricted, as used herein, refers generally to an access level that allows access to certain types of clinical information. In the above example regarding the pharmacist that is only granted access to medication clinical information, the pharmacist may be assigned a modified restricted access level indicating to only allow access to the appropriate clinical information.

When clinical information is received (e.g., by first receiving component 221), identifying component 223 is configured to identify the type of clinical information and an access level associated with each subscriber. Identifying component 223 is configured to identify the clinical information-type in order to determine which access level should be granted access to the clinical information. For example, if the clinical information is information related to medications of the user (e.g., a prescription has been ordered for the user) then it will be identified as such and only subscribers authorized to receive such clinical information will be notified of the data.

Once the clinical information-type has been identified, communicating component 224 is configured to communicate the clinical information to appropriate subscribers. Appropriate subscribers are identified as those having an access level at least as great as the access level required to be notified of the clinical information. For example, in the prescription example above, the clinical information may be associated with an access level corresponding to prescription drug information such as, for example, a modified restricted access level (e.g., as in the pharmacist example previously described). Thus, a user may approve that the prescription drug information is distributed to anyone having at least a modified restricted access level. Alternatively, a user may specifically indicate prescription drug information as a special type of clinical data such that it is only distributed to subscribers indicated as approved to receive prescription drug information. As is evident, users may set up their health profile such that a variety of levels are present to determine what information is distributed to which subscribers.

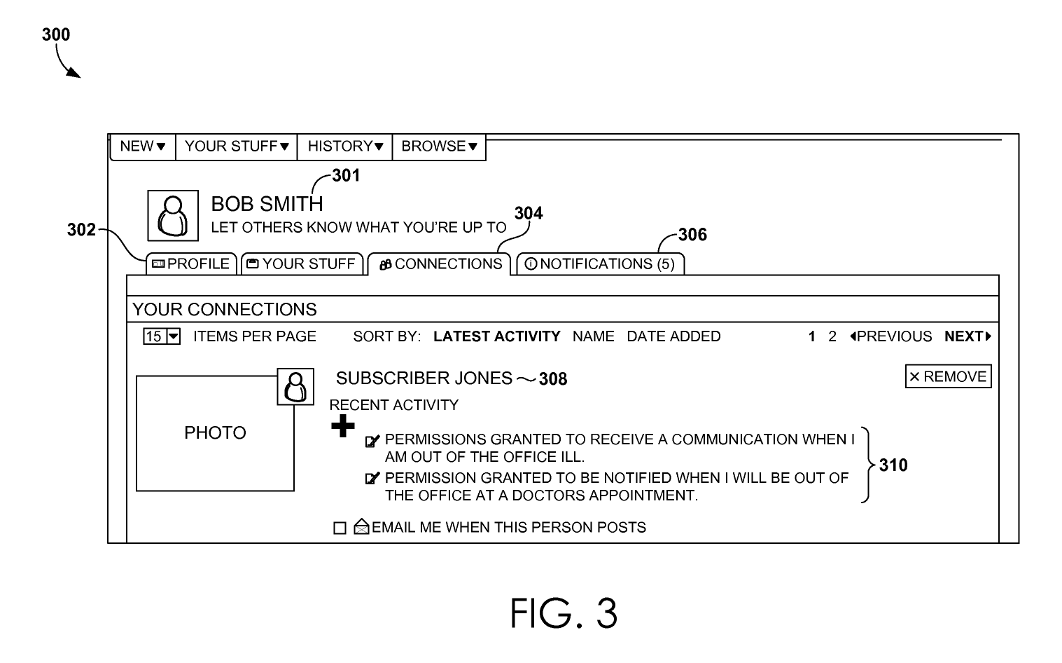

Turning now to FIG. 3, an illustrative screen shot showing a graphical user interface (GUI) 300 for managing a social health network, in accordance with an embodiment of the present invention, is provided. GUI 300 is merely exemplary and it should be noted that health profile interfaces may be set up in any fashion desired by a user.

GUI 300 illustrates a user 301 (i.e., Bob Smith), a profile tab 302, a connections tab 304, a notifications tab 306, a subscriber 308 (i.e., Subscriber Jones), and an activity feed 310. The profile tab 302 is configured such that selection thereof presents a user's health profile. In this case, Bob Smith's health profile may be presented upon selection of profile tab 302. The health profile may include all clinical information for user 301 including, but not limited to, medical history, current medications, and the like. An additional tab may be provided (illustrated as a “Your Stuff” tab in FIG. 3) that allows a user to select the tab such that any items that the user wishes to save are compiled in a centralized location. For instance, user 301 may wish to keep all records of doctor visits and all other medical records in an electronic storage location. The “Your Stuff” tab of GUI 300 allows the user to easily access their saved documents.

GUI 300 also includes connections tab 304. Connections tab 304 is configured such that selection thereof presents a list of “connections”, or subscribers. For instance, in GUI 300, connections tab 304 has been selected and subscriber 308 (i.e., Subscriber Jones) is listed. There may be more than one connection displayed at a time. The subscribers may be associated with an access level and the access level may be presented as well as the identification of subscriber 208. The activity feed 310 is presented for each subscriber and may include any recent activity such as activities of subscriber 308 or activities of user 301. Illustrated in activity feed 310 are recent activities that permission has been granted to subscriber 308 to receive a communication when user 301 is out of the office ill and that permission has been granted to subscriber 308 to be notified when user 301 will be out of the office at a doctor's appointment. Various other permissions may be presented, including a specific access level associated with subscriber 308.

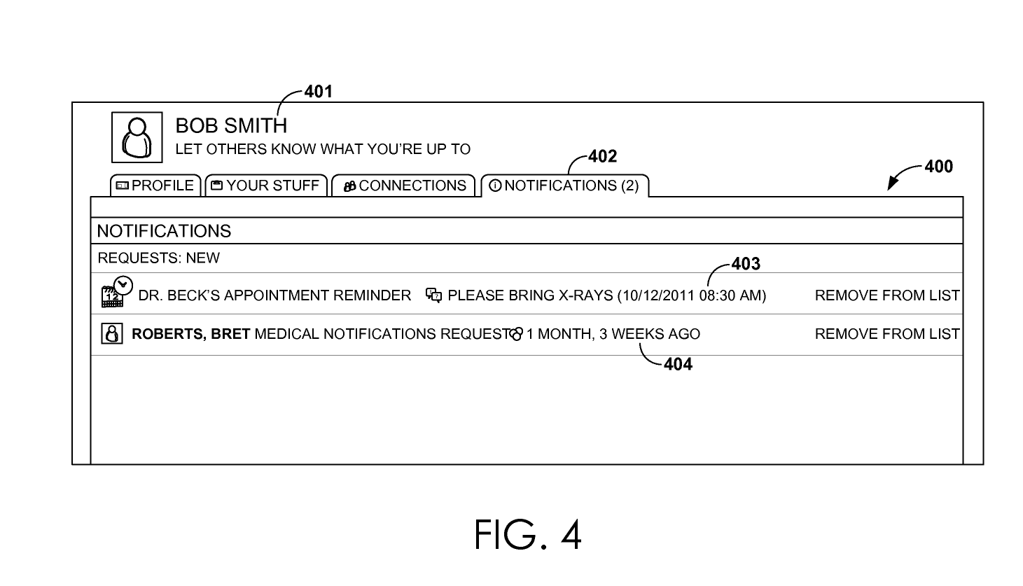

Notifications tab 306 is configured such that selection thereof presents a user with one or more notifications communicated to the user. FIG. 4 is an illustrative screen shot showing a graphical user interface (GUI) 400 for managing a social health network, in accordance with an embodiment of the present invention, is provided. In particular, GUI 400 illustrates presenting notifications to a user. In GUI 400, user 401 has selected notifications tab 402 and is presented with the GUI 400. GUI 400 includes two exemplary notifications illustrated as notification 403 and notification 404. As is evident, a reminder to bring X-rays for an upcoming appointment is included. Additionally, a request from Bret Roberts is presented to user 401 such that user 401 may accept or deny the request. Once the user has reviewed the notifications, the user may remove any notifications from the list that are no longer necessary.

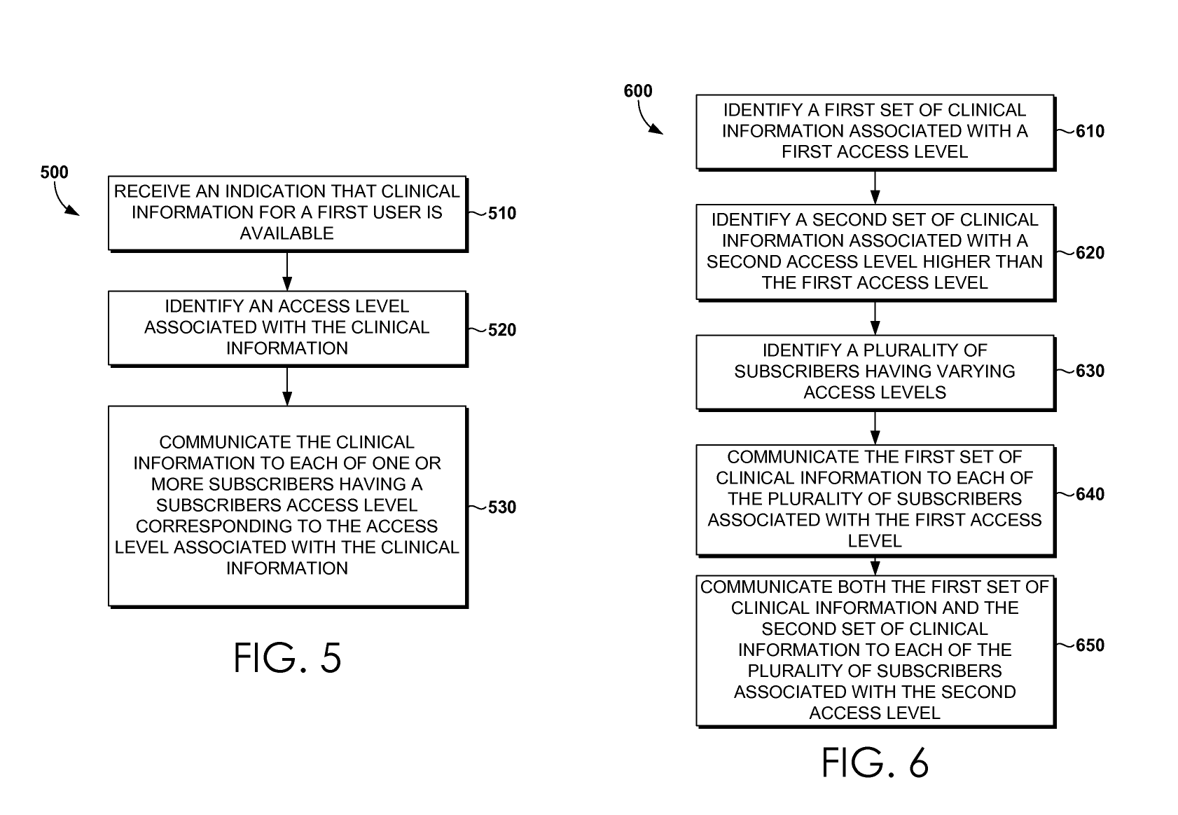

Turning now to FIG. 5, a flow diagram showing a method 500, in accordance with an embodiment of the present invention, is provided. Initially, at block 510, an indication that clinical information for a first user is available is received. The indication may be input by a user (e.g., a clinician treating the first user) or may be automatically communicated upon documentation into the first user's electronic health record, for example. Alternatively, the indication may be received upon identifying new information stored in a clinical database for the first user. At block 520, an access level associated with the clinical information is identified. The access level may be, for example, unrestricted, restricted, or modified restricted. An access level may also be identified for a subscriber of the user. At block 530, the clinical information is communicated to each of the one or more subscribers having an access level corresponding to the access level associated with the clinical information, indicating that it is appropriate for the one or more subscribers to receive the clinical information.

Referring to FIG. 6, a flow diagram showing a method 600, in accordance with an embodiment of the present invention, is provided. Initially, at block 610, a first set of clinical information associated with a first access level is identified. At block 620, a second set of clinical information associated with a second access level higher than the first access level is identified. For instance, the second set of clinical information may require an unrestricted access level while the first set of clinical information is associated with a restricted access level. At block 630, a plurality of subscribers having varying access levels are identified. The first set of clinical information is communicated to each of the plurality of subscribers associated with the first access level at block 640. At block 650, both the first set of clinical information and the second set of clinical information are communicated to each of the plurality of users associated with the second access level.

Additional embodiments are illustrated by way of the following examples. Assume that a patient visits their primary care clinician and the clinician gives the patient a work release for the patient's illness. Based on the patient's settings in their social network, a copy of the work release may be automatically communicated to the patient's employer. Also, any prescriptions that were written may be automatically communicated to the pharmacy indicated by the patient. Updates may also be sent to designated friends and family members to notify them the patient is ill. This example illustrates, potentially, three levels of access: family, work, and pharmacy.

If the patient were a child in the above example, a school release may be automatically communicated to the child's school to notify them that the child will be out of school for a period of time. Additionally, designated friends may receive a notification that the child is ill and instructions to pick up the child's assignments at school.

An additional embodiment provides for rule sets based on community data to manage patient care. For example, a parent may take their child's temperature via a wireless temporal temperature scanner. The temperature result may be high. The present invention may correlate statistics on outbreaks of flu, strep, etc. in order to manage patient care based on community data. A notification of the high temperature may be automatically communicated to the child's pediatrician. Rule sets may be configured such that the pediatrician sends a notification to a parent that the child should be seen, based on specific symptoms. Since the child in this example has an elevated fever that has persisted more than 24 hours, lists of available appointments are automatically communicated to the parent. The parent may select an appointment time slot and the appointment is scheduled. Reminders may also be incorporated into the health network so that the parent is reminded of the appointment date and time. This example illustrates that device information may be automatically communicated to the social networking system (e.g., a temperature from a thermometer, a blood sugar reading from a glucometer).

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. One or more computer storage media storing computer-useable instructions that, when used by one or more computing devices, cause the one or more computing devices to perform a method comprising:
receiving an indication that clinical information for a first user is available;
identifying an access level associated with the clinical information, wherein the access level indicates a type of information to communicate to an associated access level; and
communicating the clinical information to each of one or more subscribers having a subscriber access level corresponding to the access level associated with the clinical information, indicating that it is appropriate for the one or more subscribers to receive the clinical information.

2. The media of claim 1, further comprising identifying a rule set indicating a plurality of clinical information-types to communicate.

3. The media of claim 2, wherein the clinical information-types to communicate includes one or more of a clinical status change of the first user, a change to a medical profile of the first user, and a clinical event.

4. The media of claim 1, wherein the access level associated with the clinical information is an unrestricted access level.

5. The media of claim 1, wherein the access level associated with the clinical information is a modified restricted access level.

6. The media of claim 1, wherein the access level associated with the clinical information is a restricted access level.

7. The media of claim 1, wherein the access level associated with the clinical information indicates that it is appropriate for the one or more subscribers to receive the clinical information when a subscriber's access level is at least as great as or greater than the access level associated with the clinical information.

8. The media of claim 7, wherein a modified restricted access level is greater than a restricted access level.

9. The media of claim 8, wherein an unrestricted access level is greater than the modified restricted access level.

10. The media of claim 1, wherein the access level indicates an amount of information to communicate to an associated access level

11. A computerized system, the system comprising:
one or more computing devices having at least one processor and comprising:
a first receiving component for receiving clinical information for one or more users;
a second receiving component for receiving one or more requests from one or more subscribers, wherein the one or more requests request access to a health feed of the clinical information for at least one of the one or more users;
an identifying component for identifying one or more access levels associated with one or more of the clinical information, the one or more users, and the one or more subscribers; and
a communicating component for automatically communicating clinical information to the one or more subscribers based on the one or more access levels associated with the clinical information and the one or more subscribers.

12. The system of claim 11, wherein the communicating component communicates the clinical information to the one or more subscribers based on a subscriber-indicated preferred method of communication.

13. The system of claim 12, wherein the subscriber-indicated preferred method of communication is a designated device.

14. The system of claim 11, wherein the one or more access levels includes an unrestricted access level.

15. The system of claim 11, wherein the one or more access levels includes a modified restricted access level.

16. The system of claim 11, wherein the one or more access levels includes a restricted access level.

17. The system of claim 11, wherein the communicating component communicates the clinical information to the one or more subscribers when the one or more access levels associated with the clinical information indicates that the one or more subscriber's access level is at least as great or greater than the one or more access levels associated with the clinical information.

18. The system of claim 17, wherein an unrestricted access level is greater than a modified restricted access level and a modified restricted access level is greater than a restricted access level.

19. One or more computer storage media storing computer-useable instructions that, when used by one or more computing devices, cause the one or more computing devices to perform a method comprising:
identifying a first set of clinical information associated with a first access level;
identifying a second set of clinical information associated with a second access level higher than the first access level;
identifying a plurality of subscribers having varying access levels;
communicating the first set of clinical information to each of the plurality of subscribers associated with the first access level; and
communicating both the first set of clinical information and the second set of clinical information to each of the plurality of subscribers associated with the second access level.

20. The media of claim 19, wherein the first access level is a restricted access level and the second access level is an unrestricted access level.
